(19) United States
(12) Patent Application Publication
(10) Pub. No.: US 2010/0246342 A1
(43) Pub. Date: Sep. 30, 2010

(54) DEVICE FOR UNINTERRUPTED LISTENING TO RADIO BROADCAST

(76) Inventor: Robert IZRAELI, Bet Arie, IL (US)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/413,566

(22) Filed: Mar. 29, 2009

(51) Int. Cl. H04H 60/27

(52) U.S. Cl. 369/7; G9B/9

(57) ABSTRACT

A device for playing and recording real time broadcast radio includes a storage device, an audio output component, a control unit and an input interface. Data received from a radio receiver are recorded in the storage device. When a pause command is received from the input interface the real-time broadcast is paused, a marker is placed in the current position in memory and the received data continue to be recorded in the storage device.

### FIELD AND BACKGROUND OF THE INVENTION

The present invention relates to a radio recorder and, more particularly, to a device for recording broadcast radio with playback capabilities.

Many people enjoy listening to radio broadcast (FM/AM or other) while on the move. Whether this is in their car, while riding the train or jogging, it is very common that the joy of listening to the Radio is interrupted. Such interruptions can be the result of a sudden and unplanned loud noise such as a truck honking or a public announcement on the train. Due to the real-time nature of broadcast radio, the listener may miss out on a specific announcement or discussion on the radio with no ability to rewind and hear the portion that was missed.

On other occasions, the listener may be forced to stop listening to the radio for a longer time due to a phone call, having to stop the car for gas or at the toll bridge, a short conversation or any other type of activity that prevents the listener from listening to the radio broadcast in real time.

Various attempts have been made to provide radio content that has inadvertently been missed. These systems are either unable to provide broadcast content that has been recently missed, do not allow for ‘pausing’ real-time broadcast at will or provide overly complex systems that are impractical for use while on the move.

It would therefore be highly advantages to have a device that allows the listener to pause real-time broadcasts at will in order to continue playing the broadcast when convenient. In addition, having the ability to rewind a segment of a broadcast that was missed, is a great advantage, especially when these functions are simple and easy to perform.

The purpose of this invention is to provide radio listeners with the ability to listen to radio broadcasts without missing any part of such broadcast.

### DEFINITIONS

The terms ‘play’, ‘playing’ and ‘playback’ as used herein are all understood to mean: ‘relaying data through a system of mechanisms until it is eventually heard as analog sound waves’. The phrase ‘interrupt command’ refers to any command that interrupts the real-time playing of a broadcast, such as a pause command or stop command.

### SUMMARY OF THE INVENTION

According to the present invention there is provided a device for playing and recording real time broadcast radio and for playing back recorded broadcast radio including, a) a storage device for recording data received from a radio receiver, thereby providing recorded broadcast radio; b) an audio output component for playing the data; c) a control unit for operating the storage device and the audio output component; and d) an input interface for sending instructions to the control unit, where the instructions include: i) a pause command set of instructions that instruct the control unit to: A) stop the playing of the real time broadcast radio; B) insert a marker at the current position in the recorded broadcast radio; while continuing to record the real time broadcast radio to the storage device.

Preferably, the instructions include a rewind command set of instructions that instruct the control unit to playback the recorded data from a point in memory as determined by a user. Preferably, the instructions include a play command set of instructions that instruct the control unit to restart the playing of the data from the marker in the storage device.

Preferably the storage device is a FIFO storage device.

Preferably the input interface includes a manual interface including a Play control, a Pause control, a Fast Forward control, a Rewind control and a Resume control.

In some embodiments the input interface is configured to receive an automated command from another device, such as a cellular phone.

Preferably the device further includes a radio receiver for receiving radio broadcasts. Preferably the device further includes an audio system for playing the data.

In some embodiments the device is a self-contained device that can be operationally connected to a legacy broadcast radio receiver. Alternatively, the device is an integrated part of a broadcast radio receiver.

In a preferred embodiment of the invention, the device can be programmed to record a given broadcast at a given time. More preferably the device can record one broadcast while simultaneously playing a different broadcast.

According to the present invention there is provided a method for playing and recording real time broadcast radio and for playing back recorded broadcast radio, where the method includes the steps of: a) receiving data from a radio receiver; b) starting to record the received data as recorded data; c) upon receipt of an interrupt command: i) stopping playing of the received data; ii) inserting a marker at the current position in the recorded data while continuing to store the received data; and d) upon receipt of a play command starting playing back the recorded data from the marker.

Preferably, the method further includes the step of rewinding the recorded data in order to playback previously recorded broadcast radio, all this in response to receiving a Rewind command.

Preferably the method further includes playing the received data, e.g. in real time. Preferably the method further includes resuming playing the data in real-time after pausing and in response to receiving a Resume command. Preferably the method further includes playing back the recorded data at an accelerated speed after pausing and in response to receiving a Fast Forward command. Alternatively or additionally the method further includes skipping ahead of a current playback location in the recorded data after pausing, up to and including real-time position in the recorded data, in response to receiving a Fast Forward command.

Preferably the method further includes programming the device to record a given broadcast at a given time.

Preferably the method further includes the step of playing one selected broadcast while simultaneously recording a different broadcast.

Preferably the recording of the received data is started in response to starting to play the received data.

An “interrupt” command is defined herein as a command, such as a pause command or a stop command, that interrupts the playing of the received data. Hence, preferably, the playing of the received data is stopped, and the marker is inserted in the current position in the recorded data, in response to a pause command or to a stop command, while continuing to record the received data.

The present invention discloses an innovative method and system for manual and automatic radio broadcast recording and playing, such that a listener can listen to the entire radio broadcast or parts of it, regardless of external interruptions or the individual's availability to listen to the broadcast in real time.

### BRIEF DESCRIPTION OF THE DRAWINGS

Various embodiments are herein described, by way of example only, with reference to the accompanying drawings, wherein:

FIG. 1 is a schematic block diagram is the device;

FIG. 2 is a schematic diagram of a segment of an exemplary control panel of the current invention;

### DESCRIPTION OF THE PREFERRED EMBODIMENTS

The principles and operation of a recording and playback device according to the present invention may be better understood with reference to the drawings and the accompanying description.

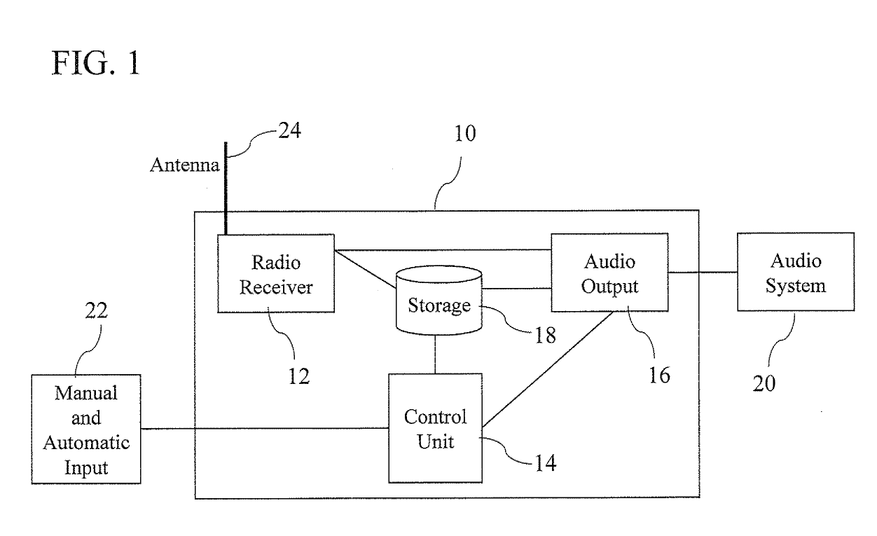

Referring now to the drawings, FIG. 1 illustrates a basic radio device of the current embodiment with additional components for recording, storage and playback. A radio receiver 12 receives AM/FM or other radio broadcasts via an antenna 24, which is operationally coupled thereto. Received broadcasts are converted into digital data by means of demodulation and analogue/digital conversion as is well known in the art (not shown). The converted data is simultaneously conveyed to a storage unit 18, where it is recorded, as well as to an Audio Output (AO) unit 16, both of which are operationally coupled to radio receiver 12. AO unit 16 is responsible for controlling what data is played. Storage unit 18 is capable of recording and playing different data items simultaneously and manages the storage space using a First-In-First-Out (FIFO) method such that when the system runs out of storage space recording will continue over the oldest existing data. In one exemplary embodiment, data received is recorded even after Audio Output unit 16 is deactivated and the radio appears to be “switched off”. Recording can continue for a predetermined time, or alternatively, recording can be ongoing. The extent of the data stored in storage unit 18 is dependent on the allotted storage capacity of the storage unit. Once storage unit 18 reaches full capacity, new data will be recorded over the oldest data in the unit, as mentioned above. In an alternative embodiment, storage can be initiated with the activation of Audio Output unit 16 (switching the radio “on”), or in a further embodiment, with the activation of a Pause control 42 (see below).

During regular, uninterrupted listening, data is conveyed from AO unit 16 to an Audio System (AS) 20, to which AO unit 16 is operationally coupled, whereby the listener is able to hear the broadcast. A control unit 14 receives instructions regarding which data should be recorded and played and at what times, from a Manual and Automatic Input (MAI) unit 22. MAT unit 22 can be manually operated or automatically activated by another device.

### Pause

In the event of an interruption, a ‘Pause’ command is sent, either automatically (triggered, for example, by answering an incoming cellular phone call) or manually (by listener activation), from MAI unit 22 to control unit 14, operationally coupled thereto. For example, if a driver of a car is listening to a radio broadcast and wishes to converse with a passenger, he activates a Pause control 42 (see below) to pause the broadcast. In an exemplary automatic embodiment, a cellular car phone is operationally coupled to the device, which is integrated into the car radio. In an alternative automatic embodiment, the device is embedded in a portable cellular phone. In both automatic embodiments, initiating and/or answering a phone call from the cellular phone automatically sends a Pause command to control unit 14. Control unit 14 sends a command to AO unit 16, which is operationally coupled thereto, to stop sending data to AS 20, effectively stopping all audio output. At the same time, control unit 14 sends a command to storage unit 18, to which control unit 14 is also operationally coupled, to place a digital marker at the current location in memory of the stored data. Storage unit 18 continues to store ‘real-time’ data it receives from radio receiver 12.

### Play

When the abovementioned interruption concludes, a command is sent, either automatically (with termination of the phone call) or manually, from MAI unit 22 to control unit 14. Control unit 14 instructs storage unit 18 to start playing the recorded broadcast from the digital marker. Simultaneously, storage unit 18 continues to receive and store data from radio receiver 12.

Control unit 14 has a number of functions, some of which have previously been mentioned. Among its functions, control unit 14 instructs storage unit 18 to start and stop the recording of incoming radio broadcast, instructs storage unit 18 which data items to play and instructs AO unit 16 whether real-time broadcast radio coming directly from receiver 12 or recorded data coming from storage unit 18, should be played.

In the most preferred embodiment of the invention, additional functions/features are available. Following, we discuss a number of them.

### Rewind

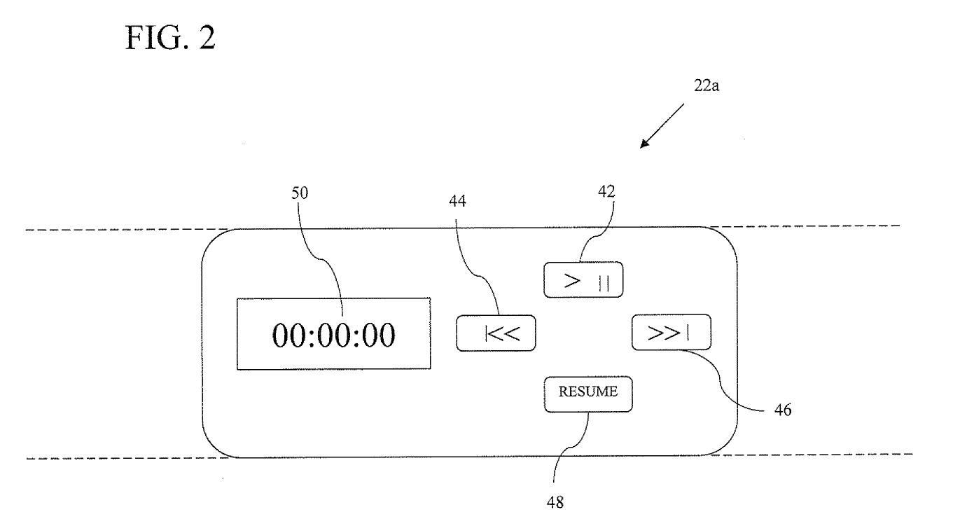

FIG. 2 is a schematic diagram of an exemplary control panel segment 22a of the current invention. Control panel segment 22a depicts an exemplary segment of MAI unit 22, specifically the manual input components thereof. In the event that ‘replaying’ of a relatively recent segment of the broadcast is desired, a rewind key 44 is activated for the duration of the expected length of time of desired replay. Various methods of rewinding are well known in the art and so do not require further discussion herein. When rewind key 44 is activated, MAI unit 22 sends a ‘rewind’ command set to control unit 14. The rewind command set includes, inter alia, the following commands: send a Pause command including the placing of a digital marker at the current location; await ‘end command’. In an exemplary embodiment there exists a display 50, which displays the current position in memory as denoted by the clock time of the recording. Whilst playing real-time broadcast radio, the display will reflect the current time. When a pause command is activated display 50 will pause to reflect the time at which the broadcast was paused. When the rewind control is activated, display 50 displays the rewinding numbers until the rewind control is deactivated. For example, if the listener wishes to rewind to the 10:00 news, he rewinds until the display shows “10:00”. Many such displays exist in the art and so do not require further discussion herein. When rewind key 44 is deactivated, a second set of instructions are sent to control unit 14, containing, inter alia, an ‘end command’ as well as the desired clock time from which to begin playback, as illustrated in the above example. Control unit 14 sends the appropriate commands to storage unit 18 and AO unit 16. Storage unit 18 sends data from the current marker to AO unit 16 for playing.

### Fast-Forward

An additional function is Fast-Forward (FF). This function can only be used after a Pause procedure. FF function is activated by engaging FF button 46 and allows recorded broadcasts to be played back at an accelerated speed, in some embodiments, and/or to skip ahead of the current position in the recording, to at the most, the real-clock time position as shown on display 50.

### Resume

Whilst listening to a recorded playback, should the listener wish to listen to a real-clock time radio broadcast, for example, to listen to an ‘on-the-hour’ news broadcast, a RESUME button 48 is activated. On activation, a ‘resume’ command is sent to control unit 14. Control unit 14, upon reception of ‘resume’ command, sends instructions to storage unit 18 and AO 16. Storage unit 18 receives instructions to stop transmitting data to AO 16 and AO 16 receives instructions to start playing data received from radio receiver 12. Display 50 will now reflect the true clock time. In some embodiments, a subsequent resume command instructs control unit 14 to revert to the previously displayed clock time and continue playing from there.

### Programming

In one embodiment of the current invention, the device can be programmed to record a given broadcast at a given time. The mechanisms for such programming are well known in the art.

When recording continuously, the device records data from the last broadcast frequency registered on the device. Alternatively, the device can be configured to record a preset frequency when the radio is inactive. When the radio is active, the device stores data from the current frequency to the storage unit. In addition, the device can be configured to record data received from one broadcast frequency and play data received from another frequency. It is to be appreciated that the device can be configured to continuously store data from a number of different broadcasts, simultaneously.

It is also appreciated that variations and modifications of this embodiment, as obvious to one skilled in the art, can be made.

The device, as described above, is intended to be either a self-contained device, which can be operationally coupled to a legacy radio receiver, or an integrated component of a radio device. Examples of such a radio device include, but are not limited to: a car radio, a cellular device with a radio receiver, an mp3 player with radio receiver and a portable radio receiver. In the case of a self contained device, coupling with a legacy radio can be accomplished via wired means or wireless means such as Bluetooth and the like as are both well known in the art.

Numerous additional applications, variations and modifications are well known in the art and it is to therefore be understood that the abovementioned functions are merely exemplary and intended only to depict a number of basic functions of the invention and are in no way intended to limit the scope of the invention and while the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A device for playing and recording real time broadcast radio and for playing back recorded broadcast radio comprising:
a) a storage device for recording data received from a radio receiver, thereby providing the recorded broadcast radio;
b) an audio output component for playing said data;
c) a control unit for operating said storage device and said audio output component; and
d) an input interface for sending instructions to said control unit, wherein said instructions include:
i) a pause command set of instructions that instruct said control unit to:
A) stop the playing of the real time broadcast radio; and
B) insert a marker at a current position in the recorded broadcast radio;
while continuing to record the real time broadcast radio to said storage device.

2. The device of claim 1 wherein said instructions further include:
ii) a rewind command set of instructions that instruct said control unit to playback recorded data from a point in memory determined by a user.

3. The device of claim 1 wherein said instructions further include:
ii) a play command set of instructions that instruct said control unit to restart the playing of said data from said marker in said storage device.

4. The device of claim 1 wherein said storage device is a FIFO storage device.

5. The device of claim 1 wherein said input interface includes a manual interface including:
i) a Play control;
ii) a Pause control;
iii) a Fast-Forward control;
iv) a Rewind control; and
v) a Resume control.

6. The device of claim 1 wherein said input interface is configured to receive an automated command from another device.

7. The device of claim 6 wherein said other device is a cellular phone.

8. The device of claim 1 further comprising:
e) a radio receiver for receiving the broadcast radio.

9. The device of claim 1 further comprising:
e) an audio system for playing said data.

10. The device of claim 1 wherein the device is a self-contained device adapted to be operationally connected to a legacy broadcast radio receiver.

11. The device of claim 1, wherein the device is an integrated component of a broadcast radio receiver.

12. The device of claim 1 wherein the device is programmable to record a broadcast selected by a user of the device at a time selected by a user of the device.

13. The device of claim 12 wherein said control unit is operative to record a first user-selected broadcast in said storage device while playing a second user-selected broadcast using said audio output component.

14. A method for playing and recording real time broadcast radio and for playing back recorded broadcast radio, the method comprising the steps of:
a) receiving data from a radio receiver;
b) starting to record said received data as recorded data;
c) upon receipt of an interrupt command:
i) stopping playing of said received data; and
ii) inserting a marker at a current position in said recorded data;
while continuing said recording of said received data; and
d) upon receipt of a play command starting the playing back of said recorded data from said marker.

15. The method of claim 14 further comprising the step of:
e) rewinding said recorded data to playback recorded data in response to receiving a Rewind command.

16. The method of claim 14 further comprising the step of:
e) Playing said received data.

17. The method of claim 14 further comprising the step of:
e) resuming the playing of said received data in real-time after pausing and in response to receiving a Resume command.

18. The method of claim 14 further comprising the step of:
e) Playing back said recorded data at an accelerated speed after pausing and in response to receiving a Fast Forward command.

19. The method of claim 14 further comprising the step of:
e) skipping ahead of a current playback location in said recorded data after pausing, up to and including real-time position in said recorded data, in response to receiving a Fast Forward command.

20. The method of claim 14 further comprising the step of programming the recording of a user-selected broadcast at a user-selected time.

21. The method of claim 14 further comprising the step of playing a first user-selected broadcast while recording a second user-selected broadcast.

22. The method of claim 14 wherein said starting to record said received data is in response to starting to play said received data.

23. The method of claim 14 wherein said interrupt command is a pause command.

24. The method of claim 14 wherein said interrupt command is a stop command.
